(19) United States
(12) Patent Application Publication
(10) Pub. No.: US 2005/0243415 A1
(43) Pub. Date: Nov. 3, 2005

(54) Display with optical fibre face plate

(76) Inventors: Anthony Cyril Lowe, Hampshire (GB); Barbara Needham, Baldock (GB); Niall Anthony Gallen, Cambridge (GB)

Correspondence Address: RADER FISHMAN & GRAUER PLLC, LION BUILDING, 1233 20TH STREET N.W., SUITE 501, WASHINGTON, DC, 20036, US

(21) Appl. No.: 10/503,569

(22) PCT Filed: Feb. 5, 2003
(86) PCT No.: PCT/GB03/00488

§ 371 Date: Jul. 13, 2005

(30) Foreign Application Priority Data
Feb. 6, 2002 (GB) 0202780.3
Feb. 6, 2002 (GB) 0202789.4
Sep. 26, 2002 (GB) 0222415.2

(51) Int. Cl. G03B 21/56

(52) U.S. Cl. 359/443

(57) ABSTRACT

An image display comprises an image display device having an array of pixel elements; and an image guide having an array of light transmission guides (80), input ends of the light transmission guides being arranged to receive light from pixel elements of the image display device, and output (90) ends of the light transmission guides providing an image output surface; in which each light transmission guide comprises a light-guiding region to promote light propagation by total internal reflection and a reflective coating (86) on the light guiding region to promote specular reflection at the region-coating interface.

This invention relates to displays.

The technology behind flat-panel displays, such as liquid crystal or plasma displays, has advanced to the stage where a single display can be economically manufactured to about the screen size of a modest domestic television set. To increase the display size of a single-unit display beyond this level introduces dramatically greater costs, lower manufacturing yields and other significant technical problems.

To provide larger displays, therefore, a hybrid technology has been developed whereby multiple smaller rectangular displays are tessellated to form the required overall size. For example, a 2×2 tessellated array of 15 inch diagonal displays, with appropriate addressing electronics to route pixel information to the appropriate sub-display, would provide a 30 inch diagonal display.

A drawback of this type of arrangement is that the active area of an individual display, that is to say, the area of the front face of the display on which pixel information is displayed, does not extend to the very edge of the physical area of the display. The technologies used, whether plasma, liquid crystal or other, require a small border around the edge of the active display area to provide interconnections to the individual pixel elements and to seal the rear to the front substrate. This border can be as small as a few millimetres, but still causes unsightly dark bands across a tessellated display.

Various solutions have been proposed to this problem, most of which rely on bulk optic or fibre optic image guides to translate or expand the image generated at the active area of the individual sub-displays.

For example, U.S. Pat. No. 4,139,261 (Hilsum) uses a wedge structure image guide formed of a bundle of optical fibres to expand the image generated by a panel display so that by abutting the expanded images, the gap between two adjacent panels, formed of the two panels' border regions, is not visible. The input end of each fibre is the same size or less than a pixel element. The optical fibres are aligned, at their input ends, with individual pixel elements of the panel display, so that the pixel structure of the display is carried over to the output plane of the image expander. Other image guides formed in this way may translate the image to provide a border-less abutment between a pair of adjacent panels.

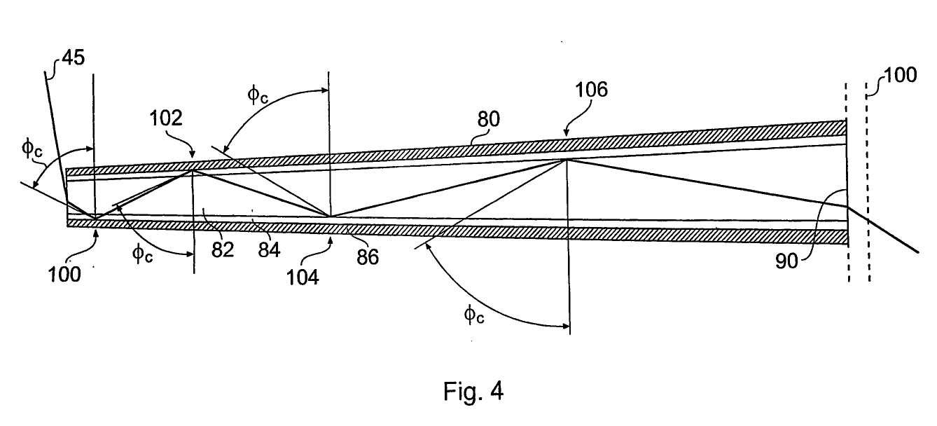

A problem which occurs in this type of arrangement is light loss by external reflection. With at least some types of display, such as photoluminescent liquid crystal, electroluminescent, or organic light emitting diode displays, the emission properties of the light emitting elements are such that light will be launched into the fibres or other light guides of an image guide at an angle less than the critical angle for total internal, lossless, reflection at the core/cladding interface. (It is noted that the sense in which the critical angle is defined affects whether the angle of the incident light must exceed or be less than the critical angle for total internal reflection to take place. The skilled man will appreciate that the sense in which the term “critical angle” is used here is as shown in FIG. 4 to be described below. In that sense, the incident light must arrive at an angle greater than the critical angle to undergo total internal reflection).

To overcome this problem it has been proposed to use a light guide with a metalised outer surface, providing specular reflection at the core-metal interface. In this case, it has been proposed that the light guides could even be hollow, so that specular reflection is provided at the air-metal interface.

However, specular reflections at a metallic interface are also lossy, and because several such reflections may occur as light progresses along the light guides of the image guide, the losses in this arrangement can also be unacceptable.

This invention provides an image display comprising:
an image display device having an array of pixel elements; and
an image guide having an array of light transmission guides, input ends of the light transmission guides being arranged to receive light from pixel elements of the image display device, and output ends of the light transmission guides providing an image output surface;
in which each light transmission guide comprises a light-guiding region to promote light propagation by refraction and/or total internal reflection and a reflective coating on the light guiding region to promote specular reflection at the region-coating interface.

The invention involves the counter-intuitive step of the light transmission guides using both specular reflection and total internal reflection/refraction, at substantially different positions along their length, to guide light from the pixel elements to the image output surface. Of course, in embodiments using total internal reflection, the cladding and reflective coating could both be present over substantially the whole length of the guide, with one or other of the two having a predominant effect at different positions along the guide. Or, in other embodiments, the cladding and reflective coating may be present over different, or partially overlapping, portions of the length of the guide.

Preferred embodiments of the invention recognise that a tapered light guide will cause progressive collimation of the guided light as the light propagates along its length from the narrower end towards the wider end. It is this recognition which allows a light guide to be used in which light at an angle of incidence less than the critical angle can initially be specularly reflected at the cladding-coating interface, but as that light is progressively collimated by the tapered light guide, its angle of incidence increases so that it can undergo (substantially) lossless propagation by refraction or total internal reflection. In this respect the light guide may be said to be “self-adjusting”. Of course, input light which is already at an appropriate angle for total internal reflection should not be specularly reflected at any part of its propagation along the light guide.

However, if a taper is not used, the light guide can still usefully accept light at angles of incidence less than the critical angle for total internal reflection, although collimation may not take place.

Although, for example, a graded index structure could be used, it is preferred that a core-cladding structure is used, which allows the reflective coating to be fabricated on the cladding.

The invention also recognises that the input light emanating from the display does not need to be matched to the input numerical aperture of the light guide because all light entering the light guide will in all cases be contained within it, either by specular or total internal reflection, and will exit only at the output face. This arrangement is important for display applications in which light which is not reflected, but which exits through the walls of the light guide may enter adjacent guides, causing loss of contrast and image degradation.

The arrangement can still operate as described even if the light guides are bent for the particular image guide design in use. If the bend is suitably gentle, total internal reflection may continue. If the bend radius decreases to a level where (without the invention) bending losses would become significant, specular reflection at the cladding-coating interface allows light to be recovered which would otherwise have been lost.

In preferred embodiments of the invention the input end of each light transmission guide receives light from a respective group of primary colour elements, each light transmission guide being arranged to mix the light from the respective group of primary colour elements so that the pixel structure within a group of primary colour elements is substantially not discernible at the output end of the light transmission guide.

This involves the counter-intuitive step of using the light transmission guides of the image guide to combine the contributions of primary colour pixel elements within a group of primary colour elements.

In previous systems using image guides, efforts have been made to preserve the pixel structure of the image display device as far as possible. For example, in U.S. Pat. No. 4,139,261 at least one light transmission guide is provided per pixel element. Indeed, using more than one light transmission guide per pixel element had a perceived advantage that the alignment between the image guide and the image display device was less critical.

However, in any colour display system where the exact pixel element structure of the image display device is carried over by the image guide to the viewing plane, the subjectively disturbing primary colour elemental structure of the image display device is also carried over to the viewer. So, on examining such a display closely, the viewer would see the individual (for example) red, green and blue elements rather than the desired colour formed as a combination of those elements.

Preferred embodiments of the invention address this problem by the elegantly simple step of combining the light from a group of primary colour elements in a single light transmission guide. As the light passes along the light transmission guide, the elemental structure within the group of primary colour elements is lost so that the output of a light transmission guide is a single colour at the luminance and chrominance levels set by the group of primary colour elements. This solution is particularly elegant in that no spatial resolution is in fact lost by the combination of primary colour elements.

Although other combinations could be used, it is preferred that the primary colour elements provide red, green and blue illumination. It is, of course, to be understood that the term “primary colour” does not imply any formally or scientifically defined set of colours, but rather the set of constituent colours used in a particular image display device to allow different output colours to be generated.

In further embodiments of the invention, each group of primary colour elements comprises one pixel element for each primary colour. However, in other embodiments each group of primary colour elements comprises n pixel elements for each primary colour, where n is an integer greater than 1. This arrangement can have several advantages. For example, in image display devices having a poor yield caused by inoperative pixels, a degree of redundancy can be built in so that n pixel elements are allocated to each light transmission guide, but only (say) (n-p) elements are ever used for display purposes. This allows the display to operate with up to p faulty pixels (in each primary colour) per light transmission guide. Another advantage may be found where each pixel element is capable of operation at m different luminance levels, and the display comprises addressing logic for supplying pixel information to the groups of primary colour elements so that each primary colour may be displayed at m×n different luminance levels. In other words, a higher colour resolution (number of displayable colours) may be obtained than is available from the physical performance of individual pixel elements.

Preferably the array of light transmission guides is arranged so that the image at the image output surface is larger than the image displayed by the image display device, and/or the array of light transmission guides is arranged so that the image at the image output surface is laterally translated with respect to the image displayed by the image display device.

Preferably each light transmission guide is substantially uniformly tapered along its length.

The materials used for the light guide are preferably as follows: the core is formed of a substantially transparent glass or plastics material; the cladding is formed of a substantially transparent glass or plastics material; and the reflective coating is formed of a metal material (e.g. silver, aluminium) or one or more layers of dielectric material (e.g. a so-called Bragg stack).

The invention also provides an image guide for use with an image display device having an array of pixel elements, the image guide comprising:
an array of light transmission guides, input ends of the light transmission guides being arranged to receive light from pixel elements of the image display device, and output ends of the light transmission guides providing an image output surface;
in which each light transmission guide comprises a light-guiding region to promote light propagation by refraction and/or total internal reflection and a reflective coating on the region to promote specular reflection at the region-coating interface.

This invention also provides a light transmission guide comprising a light-guiding region to promote light propagation by refraction and/or total internal reflection and a reflective coating on the region to promote specular reflection at the region-coating interface.

Various other respective aspects and features of the invention are defined in the appended claims. Features from the dependent claims may be combined with features of the independent claims as appropriate and not merely as explicitly set out in the claims.

Embodiments of the invention will now be described, by way of example only, with reference to the accompanying drawings in which:

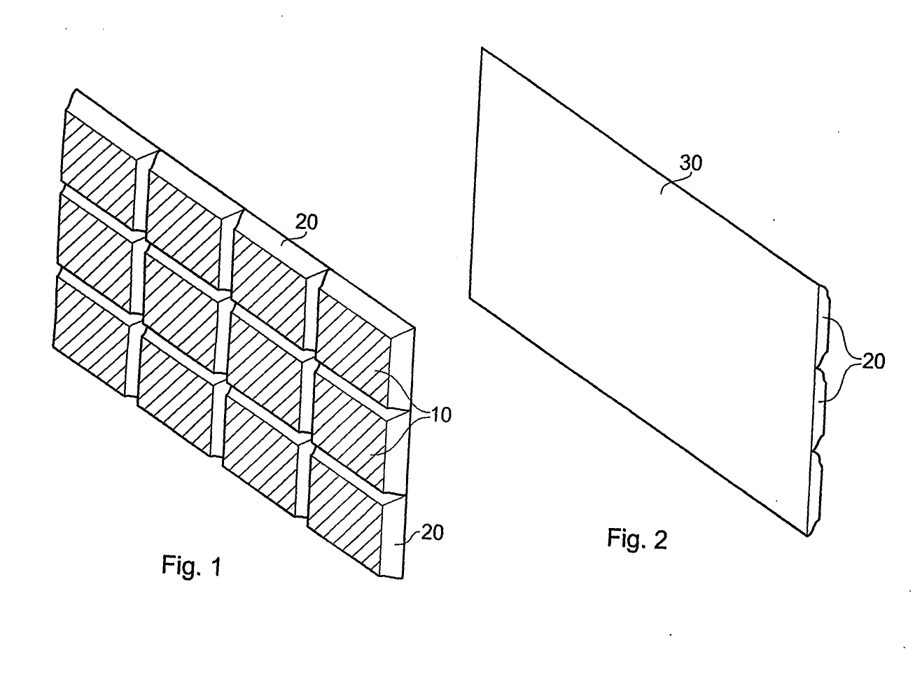

FIG. 1 is a schematic isometric rear view of a tiled array of display panels;

FIG. 2 is a schematic isometric front view of the array of FIG. 1;

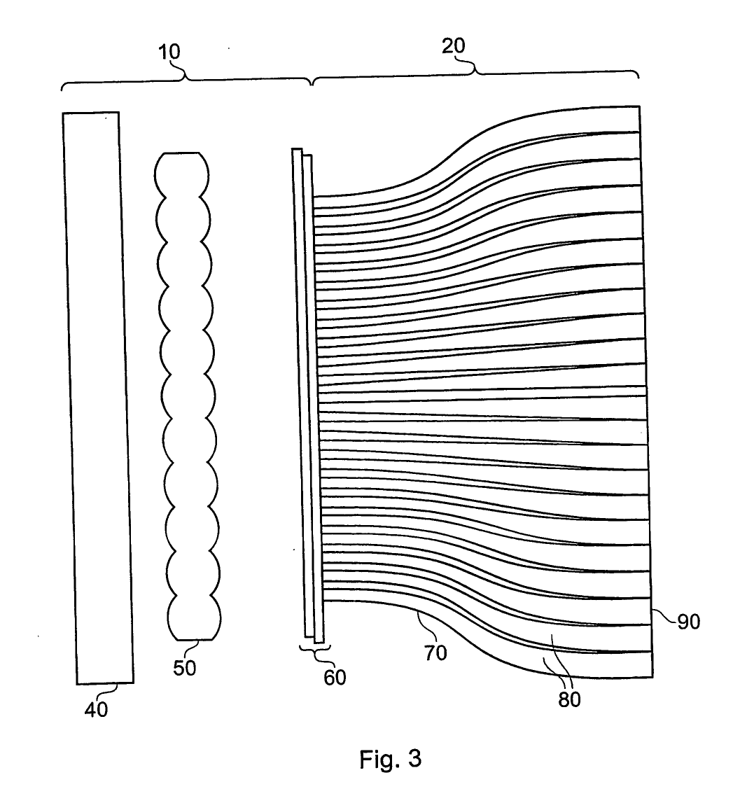

FIG. 3 is a schematic side view of a display comprising a light source, a homogeniser, a display panel and an image guide; and

FIG. 4 is a schematic side view of a light transmission guide.

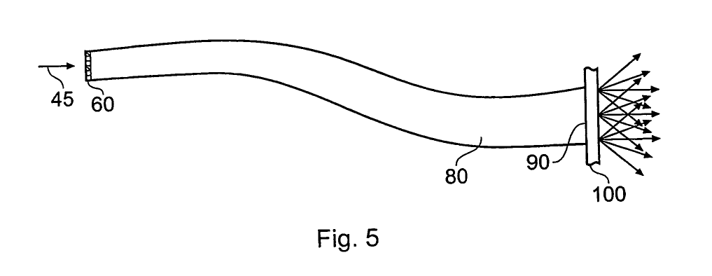

FIG. 5 is another schematic side view of a light transmission guide;

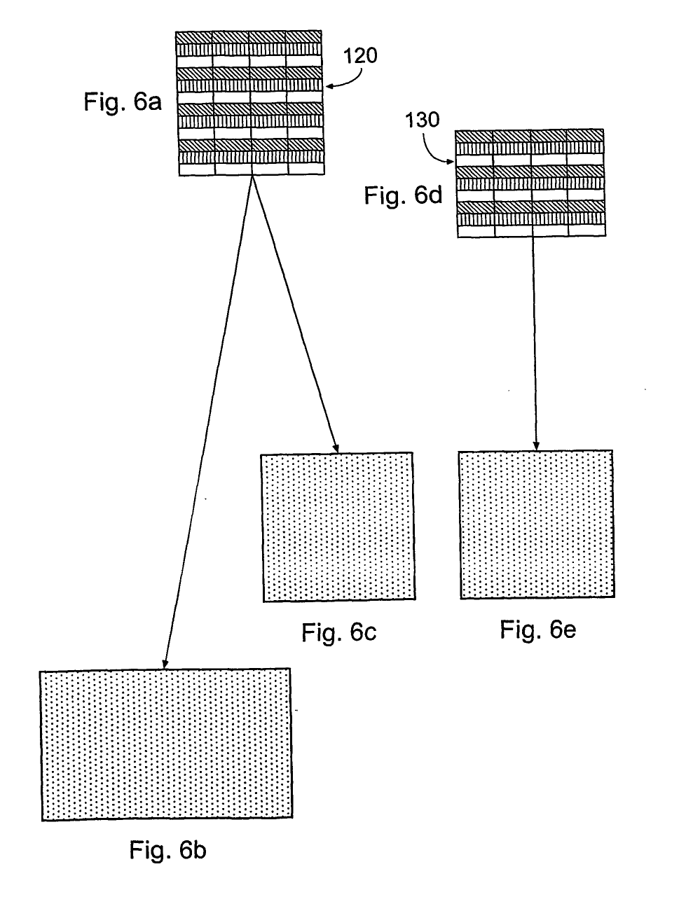

FIGS. 6a to 6e schematically illustrate arrangements by which multiple primary colour picture elements are combined at the input of a light transmission guide;

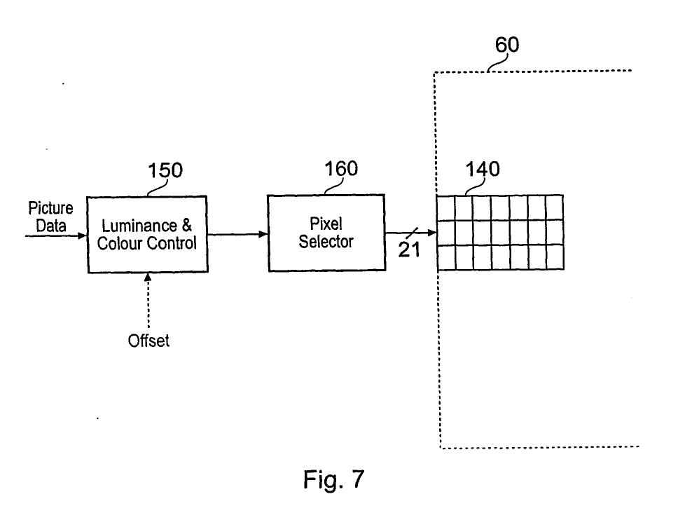

FIG. 7 schematically illustrates pixel control in a display panel;

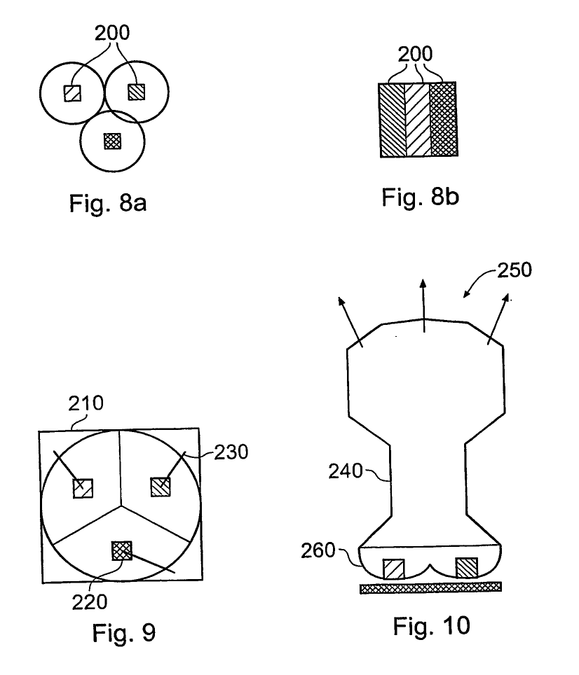

FIGS. 8a and 8b schematically illustrate light-emitting pixel formations;

FIG. 9 is a schematic plan view of an LED triode;

FIG. 10 is a schematic side elevation of the LED triode of FIG. 8, with an associated light guide;

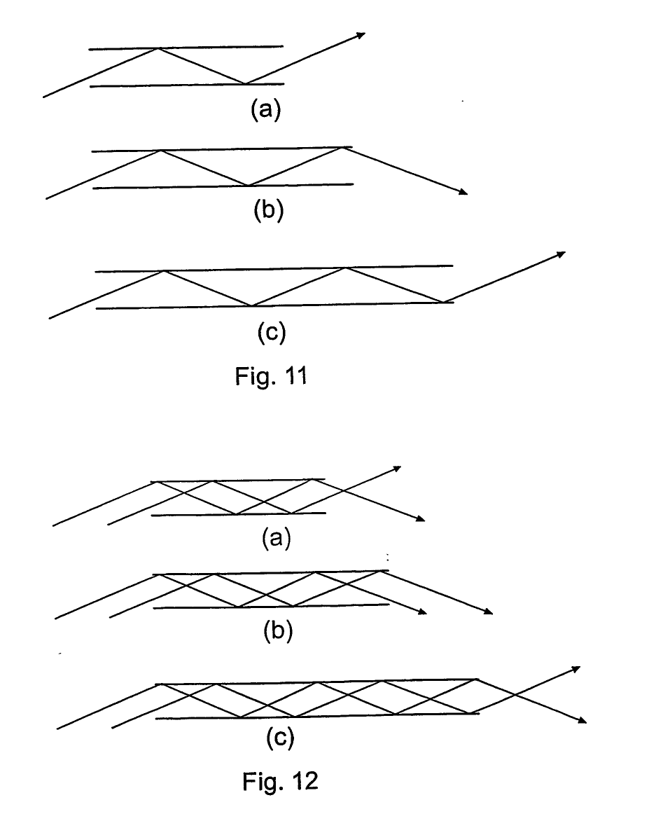

FIG. 11 is a ray diagram of a collimated beam of infinitesimal diameter in light guides of varying lengths;

FIG. 12 is a ray diagram of a collimated beam of finite diameter in light guides of varying lengths;

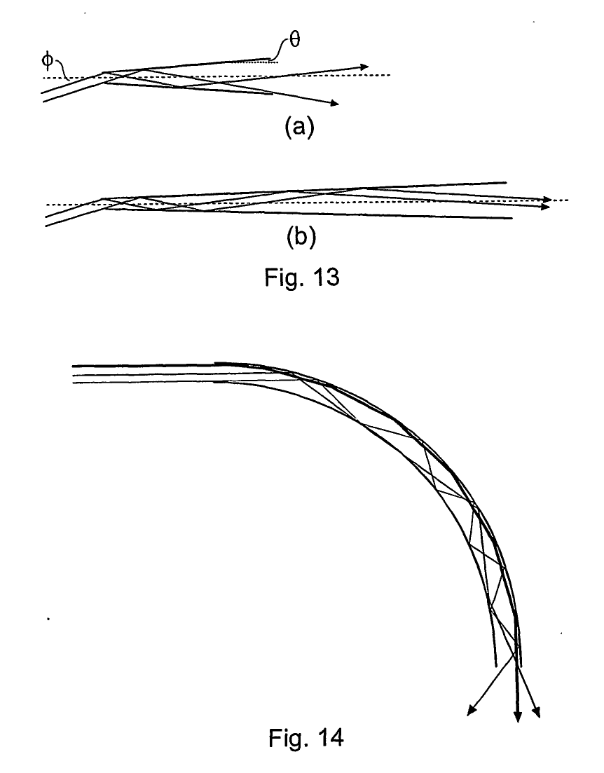

FIG. 13 is a ray diagram of a collimated beam of finite diameter in tapered light guides of varying lengths;

FIG. 14 is a ray diagram of a collimated beam of finite diameter in a curved, parallel sided light guide;

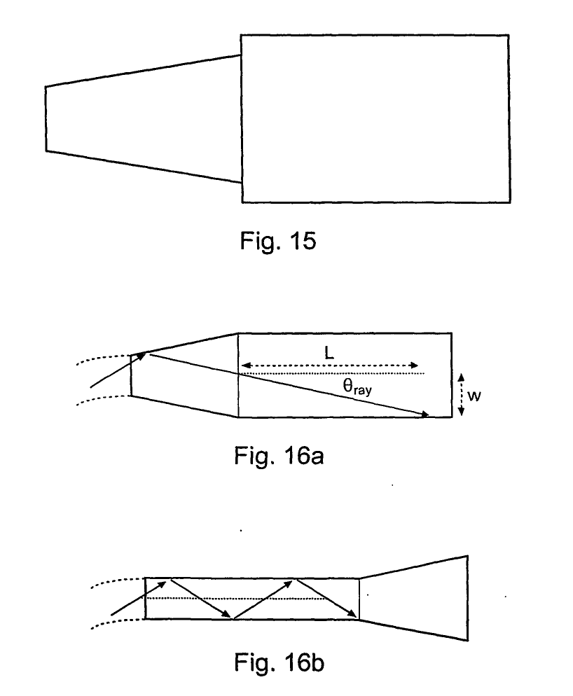

FIG. 15 is a schematic diagram of a light guide arrangement comprising a tapered section followed by a straight section;

FIGS. 16A and B are ray diagrams illustrating the behaviour of a beam travelling from a curved section of a light guide into either a tapered section followed by a straight section (16A) or a straight section followed by a tapered section (16B); and

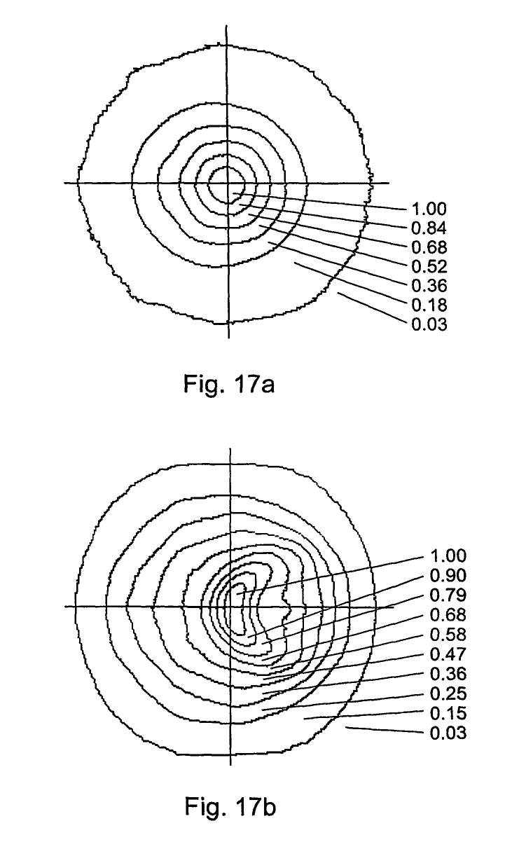

FIGS. 17A and B are angular intensity distribution plots of (17A) the angular distribution of light from a light guide after optimisation by tapered and straight end sections and (17B) the angular distribution of light from a light guide without such optimisation.

FIG. 1 is a schematic isometric rear view of a tiled array of display panels.

The array comprises four display panels in a horizontal direction and three display panels in a vertical direction. Each display panel comprises a light emitting surface 10 and an image guide 20.

The light emitting surfaces 10 are each arranged as a plurality of pixels or picture elements. In practice, they might include, for example, a back light arrangement, focusing, collimating and/or homogenising optics and a liquid crystal panel or the like, but much of this has been omitted for clarity of the diagram.

The light emitting panels each display portions of an overall image to be displayed. The portions represent adjacent tiles in a tessellated arrangement. However, because of the need to run electrical connections and physical support around the edge of the light emitting surfaces 10, they cannot be directly abutted without leaving a dark band or “black matrix” in between. So, the light guides 20 are used to increase the size of the image from each light emitting surface 10 so that the output surfaces of the light guides 20 can be abutted to form a continuous viewing plane.

This arrangement is shown in FIG. 2 which is a schematic isometric front view of the array of FIG. 1. Here, the output surfaces of the light guides 20 abut so as to form a continuous viewing surface 30.

FIG. 3 is a schematic side view of a display comprising a collimated light source 40, a homogeniser 50, a liquid crystal panel 60 and a light guide 70.

The collimated light source 40 and the homogeniser 50 are shown in highly schematic form but, in themselves, form part of the state of the art. The particular homogeniser which is schematically illustrated includes a so-called “fly's eye” type of lens to provide the back light required by the liquid crystal panel 60.

The liquid crystal panel 60 may be of a type which uses a white or other visible colour back light and provides liquid crystal picture elements to modulate that back light for that display. Alternatively, the liquid crystal panel 60 may be a photo luminescent panel which employs an ultra-violet back light and modulates the ultra-violet light onto an array of phosphors to generate visible light for display. Of course, many other types of light emitting surface 10 may be used such as an organic light emitting diode array.

The image guide 70 comprises an array of light transmission guides 80, each of which carries light from a particular area on the liquid crystal panel 60 to a corresponding particular area on an output surface 90. In doing so, the light transmission guides are arranged to diverge so that the area covered on the output surface 90 is physically larger than the image display area on the liquid crystal panel 60. This, as described above, allows an array of displays as shown in FIG. 3 to be abutted without an unsightly black matrix at the viewing plane.

FIG. 4 is a schematic side view of a light transmission guide 80. The light transmission guide 80 as shown is similar in function to an optical fibre, having an internal core 82 surrounded by cladding material 84, the core and the cladding having appropriate refractive indices so as to promote total internal reflection within the optical fibre, as long as the angle of incidence of the incoming light is greater than a critical angle φ_{c}. The cladding is surrounded by a reflecting layer 86 formed of, for example, a metal or alloy layer such as silver or aluminium (deposited by a vapour deposition technique for example) or a series of dielectric layers forming a so-called Bragg stack.

The core and cladding may be of, for example, glass or plastics materials.

In operation, illumination from the back light 40 and the homogeniser 50 passes through picture elements of the display panel 60 before entering the guide 80. The input light 45 passes along the guide and towards its output 90. In the drawing, this is shown as propagation from the left to the right of the drawing. The output end of the guide forms a viewing surface and may be covered by a diffuser panel 100.

In FIG. 4, the input light 45 is shown as initially being at an angle less than the critical angle φ_{c}. Total internal reflection does not therefore take place, and instead specular reflection takes place at the cladding-reflective layer boundary. The specular reflection is shown schematically as a reflection 100. A second specular reflection 102 also takes place.

Because of the taper of the guide 80, however, at each specular reflection the angle of incidence will progressively increase until it exceeds the critical angle φ_{c}. This occurs by a third (schematically illustrated) reflection 104, which means that the reflection 104 is a substantially lossless total internal reflection. Thereafter, reflection (e.g. a reflection 106) is by total internal reflection, cutting down subsequent losses.

Of course, if a component of the incident light is incident at greater than the critical angle φ_{c}, that component will propagate along the whole guide by total internal reflection.

Because light emerging at the output 90 of the guide is predominantly (or even all) propagating by total internal reflection at greater than the critical angle of incidence φ_{c}, a collimation effect has been achieved.

It will be appreciated that not all of the guide needs to be tapered (if indeed any of it, although then the advantageous collimation operation described above may not be obtained). For example, only an input portion of the guide might be tapered. Similarly, it is not necessary to use a core-cladding structure for the guide—instead a radially graded index structure (not shown) providing substantially lossless propagation by refraction, with a reflective coating, could be used.

Although a reflecting coating has been described, in some embodiments of the present invention no such coating is used.

FIG. 5 is another schematic side view of a light transmission guide 80. As with FIG. 4, the light transmission guide 80 as shown is similar in function to an optical fibre, having an internal core surrounded by cladding material (even air), the core and the cladding having appropriate refractive indices so as to cause total internal reflection within the optical fibre. Alternatively, the guide 80 may be in the form of a hollow tube having a reflecting inner surface, so that light within the guide undergoes multiple specular reflections as it passes along the guide. In another alternative, the guide could be formed of a solid transparent material such as glass or a plastics material but have a reflecting outer surface or coating, for example a coating of a metal such as silver or aluminium. Again, this would lead to multiple internal specular reflections as light passes along the guide. Or a graded index structure could be used.

So, in operation, illumination 45 from the back light 40 and the homogeniser 50 passes through picture elements of the display panel 60 before entering the guide 80. The light passes along the guide and towards its output 90. In the drawing, this is shown as propagation from the left to the right of the drawing. The output end of the guide forms a viewing surface and may be covered by a diffuser panel 100.

In FIG. 5, a group of several pixels form the input to a single light transmission guide. The individual pixels are shown schematically as small squares in the panel 60. In particular, the pixels are arranged as a group of n pixels of each primary colour, where n is at least 1.

In this example, the primary colours are red, green and blue, although other primary colours may be used instead. Also, having equal numbers of pixels of each primary colour assumes that the light output levels of the differently coloured pixels are appropriately matched to give the desired combined colour. In other words, the “white balance” is correct, although it is noted that this does not necessarily require equal brightness from each colour, just an appropriate set of relative brightness levels. Of course, it is not essential that the system is designed with equal numbers of each primary colour pixel in each group. For example, if pixels of one colour were, say, brighter than would be required for an appropriate balance with the other colours, then it may be sensible to use fewer of the bright colour in each group.

As the light from the group of pixels propagates along the light transmission guide, the different colours are mixed or homogenised, forming a composite colour to be seen at the output end 90. So, unlike a conventional cathode ray tube or liquid crystal display screen for example, this means that the viewer is unaware of the primary colour pixel structure, however closely the viewer observes the diffuser screen 100.

FIGS. 6a to 6e schematically illustrate arrangements by which multiple primary colour picture elements are combined at the input of a light transmission guide.

In FIG. 6a, a group 120 of primary pixels comprises 48 pixels, this being 16 of each primary colour (i.e. n=16). The different primary colours are arbitrarily identified by different respective shading. The group 120 makes up a square shape overall. So, to achieve efficient transfer into a light transmission guide, while avoiding cross-talk light from adjacent groups, the light transmission guide has a square cross-section input substantially matched in size to the physical size of the group 120.

However, it is not necessary for the light transmission guide to be square in cross section along its whole length. In fact, if a circular cross-section is used for all but an input portion and an output portion, it may be possible to bend the light transmission guides more easily (to enlarge and/or translate the image) or to obtain more efficient propagation along the light transmission guide. In any event, the cross-section need not remain constant, but, if such a change could result in a change in the direction of a reflecting surface, then to avoid unwanted reflection losses it is preferred that any changes in cross-sectional shape are made gradually rather than abruptly, so that one shape evolves gently into the next desired cross-sectional shape. If, on the other hand, such a change in cross-sectional shape does not create a surface from which the transmitted light can be reflected, such as a transition from a smaller to a larger cross-section, then an abrupt change in cross-section may be preferred.

So, whatever the cross-sectional shape in a central portion of the light transmission guide, it is possible to select a cross-sectional shape at the output 90 to match the requirements of the particular display. FIGS. 6b and 6c show two possibilities, being rectangular output pixels (FIG. 6b) and square output pixels (FIG. 6c). In this way, the output pixel shape (which is often determined by the video standard in use with the display) can be made independent of the physical layout of pixels on the panel 60.

FIGS. 6d and 6e schematically illustrate how this arrangement can work the other way around, in that FIG. 6d schematically illustrates a group 130 of primary colour pixels where the individual pixels are the same shape as in FIG. 6a, but n now equals 12 making a rectangular group. For efficient matching the input end of the light transmission guide is rectangular. The output end 90 could be rectangular (not shown) but could instead be square, as shown in FIG. 6e, or indeed any other desired cross-sectional shape.

FIG. 7 schematically illustrates pixel control in a display panel.

On a display panel 60, each light transmission guide (not shown) receives light from a group 140 of 21 primary colour pixels, i.e. n=7. Only one such group is shown for clarity of the diagram.

Assume that each primary colour pixel may operate at m different brightness levels. If only one pixel per primary colour were used in each group 140, the number of available colours would be m³. However, in a system with more than one primary colour pixel per group 140, by addressing each such primary colour pixel in the group 140 individually it is possible to obtain m×n different brightness levels for each primary colour in the group as a whole, so giving m³n³ different available colours.

This can have many advantages. The simplest one is that the arrangement can provide a display capable of displaying many more colours than are possible from the optical/electrical properties of individual pixels. In another example situation, a display can be obtained in which the output pixel at the output of each light transmission guide has m³ possible colours, but that limited range may be calibrated to lie at any desired position within a possible range of m³n³ colours. The calibration could be performed on an output-pixel-by-output-pixel basis or on a panel-by-panel basis. This could be very useful if it is desired to match the colour and/or luminance response to a desired level either within a single panel, from panel to panel or both.

FIG. 7 schematically illustrates logic for performing this operation. Input picture data is supplied to a luminance and colour controller 150. The luminance and colour controller 150 supplies data indicative of the number of primary colour pixels which need to be operated, and their required levels, to a pixel selector 160. The pixel selector 160 supplies electrical signals indicating a level of illumination to each of the pixels in the group 140. So, together the luminance and colour controller 150 and the pixel selector 160 comprise addressing logic for supplying pixel information to the groups of primary colour elements so that each primary colour may be displayed at any one of m×n different luminance levels.

Assume in a first example that the whole display is to operate at the maximum colour resolution of m³n³ colours. In this instance, the luminance and colour controller 150 receives level information for each of the three primary colours, indicative of a required level in a range from 0 to ((m×n)⁻¹).

For each primary colour, the luminance and colour controller needs to allocate required levels to the n different pixels of that primary colour in the group 140. There are many ways in which this can be done, but the choice of technique has little if any effect on what the viewer actually sees because of the homogenising effect of the light transmission guide.

In one technique, the luminance and colour controller can, for each primary colour, divide the required level by m and round down to give an integer number of pixels to be illuminated at their maximum level. The remainder (if any) forms a level of a further pixel of that colour.

In another technique, the luminance and colour controller can, for each primary colour, divide the required level by n and round down to give an average level for each of the n pixels of that primary colour in that group. The remainder (if any) is added to the level of an arbitrary one of those pixels.

The pixel selector receives the level information from the luminance and colour controller 150 and allocates levels to individual pixels. This can be done on an arbitrary basis, using a predetermined order of usage of the individual pixels.

Consider now the case where only m³ colours are required, but at a calibrated position within a range of m³n³ colours. In this case, the luminance and colour controller 150 receives an “offset” level for each primary colour, which is between 0 and ((m×(n−1))−1). To this, the luminance and colour controller adds the currently received level for each primary colour which will be in a range from 0 to (m−1). The processing then continues as described above.

As well as flat panel displays, all of these techniques are applicable to discrete pixel displays, such as (for example) signboards formed of individual primary colour light-emitting elements such as red, green and blue light emitting diodes (LEDs).

Colour signboard and advertising display modules which typically use groups of individual red, green and blue primary colour LEDs for each black and white pixel can suffer from reduced image quality due to perception of the individual colours when viewed at a distance inside the visual perception limit for the eye (e.g. less than about 3 m from the display for 1.5 mm pixel signboards). The usable range of viewing distance would be increased and the image quality increased if the red, green and blue within a pixel were homogenised. The image would be further improved if the homogenised pixel formed from the small LED sources was also increased in size to butt closely against neighbouring pixels.

This can be achieved using a homogenising element such as an image guide as described above. This approach could be used for any display using colour sub-pixels (e.g. (LEDs, EL, OLED, Vacuum Fluorescent, LCD). Application of this approach in large pixel data signboards provide a means to achieving full colour large text which is also readable from close to the display.

This arrangement provides a means for homogenising colour sub-pixels by addition of an array of (for example) plastics mouldings laminated or placed on the outside surface of the display. The same technique can also provide means for the apparent size of the emitting area to be increased to allow pixels to butt directly against their neighbours, eliminating the black mask between pixels at the viewing surface.

To illustrate these techniques, FIGS. 8a and 8b schematically illustrate in plan view the layout of two different groups of LED primary colour elements forming respective white pixels. These groups of primary colour elements may be combined using respective light transmission guides of an image guide as described above.

FIG. 9 schematically illustrates a plan view of a three-element LED, otherwise known as an LED triode, having a substrate 210 and three anodes 220 with respective connection wires 230, the anodes providing different coloured illumination. In side elevation (FIG. 10) this arrangement may form the input to a single light transmission guide 240, so providing colour-homogenised light at the output face 250. A substantially transparent adhesive or potting compound 260 may be used to provide an optical and physical connection between the LED arrangement and the light transmission guide. It is noted that there is no need in this application for the image guide to provide a diverging effect.

It is advantageous for optical efficiency if the input face of an array of light guides is substantially filled with light guide aperture able to accept and transmit image light. Thus, light guides that are substantially rectangular in section offer superior performance to those that are circular. The nature of the process by which the light guides are made may require minor departures from a perfect rectangular shape, for example to trapezoidal or irregular hexagonal, but as long as the cross section is substantially rectangular, the requirement for maximum packing efficiency will substantially be met. Additionally, in the case of LEDs or LEPs (Light Emitting Polymers) with circular or hexagonal reflectors, efficiency will be enhanced by matching the shape and dimensions of the guide input aperture to the shape and dimensions of the modulator.

The eye of the display user is accustomed to viewing a rectilinear array of substantially rectangular picture elements on the display viewing or output surface, so it is advantageous if the output surface of an array of light guides satisfies this condition, with the output cross-section of the light guides being substantially rectangular (or alternatively hexagonal or trapezoidal) in section and substantially close packed. Such an arrangement has significantly superior visual properties over, for example, an array of light guides of circular cross section.

If an array of light guides is to be suitable for tessellation into a larger assembly, so as to form a very large display surface, the input ends of the light guides must be smaller in dimension than the output ends such that the output face of the array is larger in dimension than the display target to which the input face is attached.

It is important for visual performance at a range of viewing angles that the relationship between the intensity of light emitted by a light guide and the angle at which it is emitted is substantially the same at all points in an array of light guides. Moreover, it is generally advantageous if the maximum intensity is observed normal to the plane of the output face of the light guide.

If the light guides are formed into an array which meets the requirements for tessellation, then only the central guide in an array will be linear in form. All other guides will be bent into a sigmoid form, with the degree of bend increasing progressively from the centre to the edges of the array. The sigmoid form is required because, if the intensity vs. angle requirements stated above are to be satisfied, then it is necessary that the output ends of the light guides must be substantially perpendicular to the plane of the array of light guides.

If the input and output pitches of the image guide are to be different in size, there are two means by which this can be achieved. Either, the cross-sectional area of the light guides is kept constant and their packing density is different at the input and output ends or their cross-sectional area is different at the input and output ends and a transformation of cross-sectional area occurs at some point between them. Only the second of these means meets the requirements for substantially close packing at the input and output ends identified above.

It is advantageous if the light guides are substantially circular in cross section over that part of their length where bending occurs. Also, to create the sigmoid shape needed to satisfy the angular intensity distribution characteristics, the cross-sectional area of the light guides should be smaller than the cross-sectional area of the output end over a substantial portion of the length of the guide, otherwise the light guides will not pack satisfactorily. Such a transformation can be achieved by transforming the substantially square section of the input end into a circular section of diameter substantially equal to the dimension of the side of the input end, or possibly into an equivalent ellipsoid if the input end is rectangular in section. The transformation to a larger section near the output end could be achieved by a step.

The effect which the light guide shape will have on the ray geometry of light entering and leaving the light guides will now be illustrated with reference to FIGS. 11 to 14. FIG. 11 illustrates that the direction in which a coherent beam, which for the purposes of the present discussion is one that is collimated and of infnitesimal diameter, leaves a parallel sided light guide will be a function of the length of the light guide. It can be seen that, depending in the length of the light guide, the ray will exit at the same angle with respect to the light guide axis at which it entered, but either in an up or down direction. The beam direction therefore exhibits a bistability with respect to the light guide length.

FIG. 12 illustrates the case of a real beam, still collimated, but of a width comparable to that of the light guide. Different parts of the beam will now have different paths along the light guide with the result that, although there is still a significant dependence between the length of the light guide and the fraction of the beam exiting the light guide in an up or down direction, the discontinuous bistable behaviour observed for a single ray has been lost. However, all the rays still exit at their incident angle with respect to the light guide axis.

FIG. 13 illustrates the case where, instead of being parallel sided, the light guide is tapered. In this case a similar, continuous change in exit direction with variation in the length of the light guide is observed as with the parallel sided light guide, but now the direction of the rays changes, depending on the number of reflections that have taken place within the tapered section. If the half angle of the taper is θ and the angle of the incident beam with respect to the taper axis is φ, then the modulus of the angle at which a ray will exit the light guide will be |φ−2θ×n|, where n is the number of reflections. The action of the taper is progressively to collimate the light as the number of reflections increases.

FIG. 14 illustrates the effect of a curved, parallel-sided light guide on a beam of finite diameter. The effect of a bend is more difficult to calculate. A beam of comparable diameter to that of the light guide is incident at the left had side. It will be seen that the number of reflections and the angles at which the reflections occur are strongly dependent on the position of the ray within the beam and that the direction and angle at which a ray leaves the light guide now varies over a wide range.

These simple cases demonstrate some of the properties of different sections of a light guide. However, the situation in a real display is more complex than these simple examples suggest. The light entering a light guide has, in general, a distribution of intensity vs. angle which is symmetric about the axis of the input end of the light guide and which fills the numerical aperture of the light guide. Three-dimensional modelling studies, using many thousands of rays, show that there is a tendency for a beam exiting a bend in the light guide to be directed away from the centre of curvature of the bend.

In some circumstances it may be advantageous to include a step change along the cross-section of the guide as well as the tapered structure. This is illustrated in FIG. 15. This will combine one aspect ideal for the optical angular output and another for the mould flow in the moulding process. Both will have to accommodate a standard screen format. As an example, the taper may want to be of a particular angle and length but the mould flow may want a bigger aperture at output. On top of this are the restrictions of standard LC panel pixels that define the pixel magnification based on the tiled display screen size and format.

The use of a straight section at the output of the light guide can be used to accommodate these requirements by virtue of providing a larger cross-section (highly exaggerated in the diagram) than that of the taper output. In this way the best optical output for the pixel can be ‘magnified’ to match the screen size and format without changing the angular distribution.

A further possibility is that the taper may have a different angle along different axes, for instance the taper may extend out to the end straight section in the vertical direction thereby producing more collimated light but not extend the whole way in the horizontal direction thereby having the required larger viewing angle.

In an alternative arrangement, the output straight section is located preceding the output taper. This arrangement has been considered in a simulation of a guide that approximates a pixel magnification and displacement close to the expected values for the proposed M=1.1 magnification of a 4×0.297 mm input pixel from a 15″ XGA panel. The effect of the straight section is made more efficient because the angles arriving from the output bend have not yet been collimated by the taper and so are larger. This means that over a short length of straight section (˜4 mm) there is substantial mixing of the angle along the straight section. For a straight section located after the taper the angles made with respect to the guide axis are much smaller and so the frequency at which they impinge on the walls of the straight guide is longer. This is compounded by the fact that after the output taper the cross-section of the guide has also increased. Starting from the centre of a guide, a simplified equation for the progression of a ray is given by relating the length along the guide to the width of the guide.

In general, light guides according to embodiments of the invention may have the following formations along at least a part of their length, when considered in a direction from their input towards their output:
curved; straight non-tapered; tapered; straight non-tapered
curved; tapered; straight non-tapered
   The format curved; straight non-tapered; tapered is also possible but is not preferred, because it can be difficult to fix the final tapered sections together to form an output image plane.

FIGS. 16A and 16B illustrate the cases of a straight section located after the taper and before the taper respectively. These figures show the path length from the centre of the straight section to the side of the guide for the two cases. In the case of 16A, the wider guide and more collimated ray mean that the ray hits the wall at a much greater distance along the guide than with 16B. This can be called the ‘mixing frequency’. In the case of 16B the unaltered angle from the bend undergoes four reflections for the same length straight section. A simple model for the described behaviour is given by the expression tan θ_{ray}=w/L. It can be seen from this that a straight section before the output taper out-performs a post taper straight section in respect of angle mixing.

An array of light transmission guides may be glued together to form an image guide using, preferably, a low index glue at the input and output. If the guides have reflecting outer layers at the glued positions, then the glue may be of any refractive index and may even be absorbing.

In a case where no reflecting layer is provided, to provide good optical efficiency, it is necessary to ensure that the input bend radius is defined to match the backlight distribution after passing through the glue region (if applicable) and the input taper. It is important that the input bend and input taper (in air) should be able to accept the light of numerical aperture that is guided through the glue region even though the angles of incidence have been increased by both these features due to decrease in the critical angle at a guide-air interface compared to a guide-glue interface. If the output bend radius is equal to or greater than that of the input then the light will be contained by the guide.

The output cross-sectional transformations described above involve an increase in the dimensions of the guide. This is, in effect, an increase in the aperture of the ‘system’ and as such can be used to collimate the light. The fundamental equation governing this results from the radiance invariance for a lossless system. The illuminance is defined as E=Φ/A, where Φ is the flux and A is the aperture area. Therefore, for a lossless system,
E₂/E₁=A₁/A₂

The two illuminances, E1 and E2, can also be defined in terms of the
E₁=πL₁ sin²αE₂=πL₂ sin²δ
Luminance, L.

Where ∝ and δ are the half angles of the cone of light and L is the luminance. L₁ and L₂ are related through the refractive indices at an interface and remain invariant through any system. For an input aperture A₁ that is smaller than the output aperture A₂, and for the same refractive index the relationship becomes,
E₂/E₁=sin²α/sin²δ

This means that the expansion of the flux from A₁ to A₂ can be used to reduce the angular distribution of the light from α to some smaller angle δ using a tapered section of guide. Light entering such a taper will be redirected towards the axis, thereby reducing the angle made with respect to the axis. The axes of the tapered sections of the guides in an array can be made to be parallel, thereby producing a defined distribution of light normal to the display surface for all the guides by counteracting the angular distribution increase caused by the displacement of the light by the curved guides. This provides the ability to equalise the angular distribution of the light emerging from an array of guides with different displacements.

However, it is not enough to define the angular distribution of light by a simple maximum angular extent. Instead, the relative intensities (luminance) of the individual directions must be made substantially equivalent for different guides, particularly those defining the boundary between two arrays. That is to say, that at a given angle from the normal to the display the luminance from each pixel should be substantially equivalent. This means that the angular distribution at the output of the guide should be a slowly varying well-defined angular distribution. Optionally, this can then be sent through a diffuser to produce an even more uniform luminance for all points on the screen. The effect of the curved shape of the guide (i.e. the bends) are discussed here in terms of their effect on the angular distribution.

Two factors determine the relative intensities of the angular distribution of light as it passes through a guide. One is the angular distribution at input and the other is the position at input. Two parallel rays entering at different points on the input aperture to pass through a structured and bent guide will exit the guide at different angles. Consider a ray as an infinitesimally narrow cone of light with a well defined central direction. For each set of identical ray directions input across the aperture a range of angles will be output. This is because the walls of the guide can be considered as an infinitesimally faceted network of mirrors, each at a particular angle. Each reflection will alter the direction of a ray incident upon it. The displacement of the flux due to the S-shape of the guide will redirect it as a whole towards the local axis of the guide due to the series of total internal reflections. This means that the flux arriving at the output bend will substantially directed (with, of course, an angular distribution) along the direction of the middle straight section of the guide. The output bend will redirect some, but not all, of the light in the required output direction. It is for this reason that the output straight section is located after the output bend. It has an axis parallel to the normal of the display and directs the light distribution in this direction. The range of the distribution will be increased as the range of angles of the infinitesimal mirrorsincreases. The output taper is used to reduce this range by collimating in the required direction as a means of making the outputs across an array of guides equivalent (different bends or S-shapes having different sets of infinitesimal mirrors).

From the above it can be seen that the straight section after the bend determines the axial symmetry of the output beam and the taper after the bend determines the angular extent of the beam. In the limit, the taper could be a step transformation of the cross sectional area, if the widest possible angular extent is required.

FIGS. 17A and 17B illustrate the effect of the straight and taper sections on the angular distribution of light exiting from a light guide located at the corner of an array of light guides (i.e. where significant curvature of the light guide is present). FIG. 17A illustrates the case where these two structures are present, with the angular distribution being substantially uniform. This would provide an equivalent angular distribution to that of a ‘central’ light guide with substantially no curvature. In contrast FIG. 17B illustrates the same case, but where no output straight section and no output taper are present, that is, the light exits directly after the bend. It can be seen that the ‘optimised’ output of FIG. 17A will provide much better uniformity across the face of a display at any viewing angle. The arrangements described therefore advantageously use the design of the tapered and straight sections of the light guide following the bend to substantially destroy coherence in the light beam and to cause the distribution of intensity about the axis of the exit portion of the light guide to be substantially angularly symmetric.

1. An image display comprising:
an image display device having an array of pixel elements; and
an image guide having an array of light transmission guides, each light transmission guide being tapered along at least part of its length so as to have a smaller cross-sectional area at its input end than at its output end, input ends of the light transmission guides being arranged to receive light from pixel elements of the image display device, and output ends of the light transmission guides providing an image output surface;
in which each light transmission guide comprises a light-guiding region to promote light propagation by refraction and/or total internal reflection and a reflective coating on the light guiding region to promote specular reflection at the region-coating interface.

2. A display according to claim 1, in which each light transmission guide is substantially uniformly tapered along its length.

3. A display according to claim 1, in which at least some of the light transmission guides comprise, in a direction from their input to their output, a curved region, followed by a tapered region, followed by a straight non-tapered region.

4. A display according to claim 1, in which at least some of the light transmission guides comprise, in a direction from their input to their output, a curved region, followed by a straight non-tapered region, followed by a tapered region, followed by a straight non-tapered region.

5. A display according to any one of claims 1, 3 and 4, in which some or all of the light transmission guides have a step change in cross sectional area.

6. A display according to any one of claims 1, 3, and 4, in which at least some light transmission guides have different degrees of taper in different planes parallel to the longitudinal axis of the guides.

7. A display according to claim 1, in which the light guiding region is formed of a substantially transparent glass or plastics material.

8. A display according to claim 1, in which the light guiding region comprises a core and a cladding layer on the core to promote total internal reflection at the core-cladding interface.

9. A display according to claim 8, in which the core is formed of a substantially transparent glass or plastics material.

10. A display according to claim 8, in which the cladding is formed of a substantially transparent glass or plastics material.

11. A display according to claim 1, in which the light guiding region has a radially graded refractive index so as to promote light guiding by refraction.

12. A display according to claim 1, in which the reflective coating is formed of a metal material.

13. A display according to claim 1, in which the coating is formed of one or more layers of dielectric material.

14. A display according to claim 1, in which the pixel 25 elements comprise primary colour elements providing red, green and blue illumination.

15. A display according to claim 1, in which the array of light transmission guides is arranged so that the image at the image output surface is larger than the image displayed by the image display device.

16. A display according to claim 15, in which the output ends of the light transmission guides tessellate to form a substantially close packed array at the image output surface.

17. A display according to any claim 1, in which the input ends of the light transmission guides tessellate to form a substantially close packed array at the image display device.

18. A display according to claim 1, in which the array of light transmission guides is arranged so that the image at the image output surface is laterally translated with respect to the image displayed by the image display device.

19. A display according to claim 1, in which the input end of each light transmission guide receives light from a respective group of primary colour elements, each light transmission guide being arranged to mix the light from the respective group of primary colour elements so that the pixel structure within a group of primary colour elements is substantially not discernible at the output end of the light transmission guide.

20. A display according to claim 19, in which each group of primary colour elements comprises one pixel element for each primary colour.

21. A display according to claim 19, in which each group of primary colour elements comprises n pixel elements for each primary colour, where n is an integer greater than 1.

22. A display according to claim 21, in which each pixel element is capable of operation at in different luminance levels, the display comprising addressing logic for supplying pixel information to the groups of primary colour elements so that each primary colour may be displayed at any one of in m×n different luminance levels.

23. A display according to claim 1, comprising a diffusion screen disposed at the output of the image guide.

24. A display according to claim 1, in which input ends and output ends of the light transmission guides have different respective cross-sectional shapes.

25. A display according to claim 24, in which the output ends of the light transmission guides are square.

26. A display according to claim 24, in which the output ends of the light transmission guides are rectangular, hexagonal or trapezoidal.

27. A display according to claim 1, in which the pixel elements are discrete light emitting devices

28. A display according to claim 27, in which the light emitting devices are semiconductor devices.

29. A display according to claim 1, in which the image display device comprises a panel array of light modulating pixels and a backlight arrangement.

30. An image guide for use with an image display device having an array of pixel elements, the image guide comprising:
an array of light transmission guides, each light transmission guide being tapered along at least part of its length so as to have a smaller cross-sectional area at its input end than at its output end, input ends of the light transmission guides being arranged to receive light from pixel elements of the image display device, and output ends of the light transmission guides providing an image output surface;
in which each light transmission guide comprises a light-guiding region to promote light propagation by refraction and/or total internal reflection and a reflective coating on the region to promote specular reflection at the region-coating interface.

31. A light transmission guide, tapered along at least part of its length so as to have a smaller cross-sectional area at its input end than at its output end, comprising a light-guiding region to promote light propagation by refraction and/or total internal reflection and a reflective coating on the region to promote specular reflection at the region coating interface.

32. An image display comprising:
an image display device having an array of pixel elements arranged as groups of primary colour elements; and
an image guide having an array of light transmission guides, input ends of the light transmission guides being arranged to receive light from pixel elements of the image display device, and output ends of the light transmission guides providing an image output surface;
in which the input end of each light transmission guide receives light from a respective group of primary colour elements, each light transmission guide being arranged to mix the light from the respective group of primary colour elements so that the pixel structure within a group of primary colour elements is substantially not discernible at the output end of the light transmission guide.

33. An image display comprising:
an image display device having an array of pixel elements; and
an image guide having an array of light transmission guides, each light transmission guide being tapered along at least part of its length so as to have a smaller cross-sectional area at its input end than at its output end, input ends of the light transmission guides being arranged to receive light from pixel elements of the image display device, and output ends of the light transmission guides providing an image output surface;
in which at least some of the light transmission guides comprise, in a direction from their input to their output, a curved region, followed by a tapered region, followed by a straight non-tapered region.

34. A display according to claim 33, in which at least some of the light transmission guides comprise a straight non-tapered region between the curved region and the tapered region.

35. A light transmission guide, tapered along at least part of its length so as to have a smaller cross-sectional area at its input end than at its output end, and comprising, in a direction from its input to its output, a curved region, followed by a tapered region, followed by a straight non-tapered region.

36. A guide according to claim 35, comprising a straight non-tapered region between the curved region and the tapered region.
